(19) United States
(12) Patent Application Publication
(10) Pub. No.: US 2013/0122379 A1
(43) Pub. Date: May 16, 2013

(54) LITHIUM-ION BATTERY AND METHOD FOR FABRICATING THE SAME

(71) Applicants: Bing-Joe Hwang, Taipei City (TW); Fu-Ming Wang, Hsinchu City (TW); Chia-Hui Lee, New Taipei City (TW)

(72) Inventors: Bing-Joe Hwang, Taipei City (TW); Fu-Ming Wang, Hsinchu City (TW); Chia-Hui Lee, New Taipei City (TW)

(73) Assignee: National Taiwan University of Science and Technology, Taipei (TW)

(21) Appl. No.: 13/425,405

(22) Filed: Mar. 20, 2012

(30) Foreign Application Priority Data
Nov. 16, 2011 (TW) 100141858

(51) Int. Cl. H01M 10/02; H01M 2/14

(52) U.S. Cl. 429/347; 29/623.1

(57) ABSTRACT

A lithium-ion battery and a method for fabricating the same are provided. The lithium-ion battery includes an anode, a cathode, a separator, and an electrolyte solution. The cathode is disposed opposite to the anode. The separator is disposed between the anode and the cathode, where an accommodating region is defined by the anode, the cathode and the separator. The electrolyte solution disposed within the accommodating region includes an organic solvent, a lithium salt and an additive. The additive includes a sulfonyl-containing species, and the content thereof is 0.1 to 5 wt % based on the total weight of the electrolyte solution. The whole-cell potential of the lithium-ion battery is 4.5 V or above. In the lithium-ion battery and the method for fabricating the same of the invention, the sulfonyl-containing species serves as the additive, so that the battery is capable of being operated under a condition of high-voltage charge and discharge.

### CROSS-REFERENCE TO RELATED APPLICATION

This application claims the priority benefit of Taiwan application serial no. 100141858, filed on Nov. 16, 2011. The entirety of the above-mentioned patent application is hereby incorporated by reference herein and made a part of this specification.

### BACKGROUND OF THE INVENTION

1. Field of the Invention

The present invention generally relates to a lithium-ion battery, and more particularly to a high-voltage lithium-ion battery.

2. Description of Related Art

Because primary batteries do not meet environmental protection requirements, rechargeable secondary batteries have gradually received attentions in recent years. At present, portable electronic products such as digital cameras, mobile phones, and notebook computers all require light-weight batteries. With the rapid development and generalization of the portable electronic products, the market demand for the rechargeable and dischargeable lithium-ion battery with properties of light weight, high voltage, and high energy density has been increased day by day. In addition, compared with a conventional lead battery, nickel-hydrogen battery, nickel-zinc battery, and nickel-cadmium battery, the lithium-ion battery has the advantages such as high working voltage, high energy density, light weight, long service life, and environmental protection, thus being an optimum choice among flexible batteries for the future application. Therefore, increasingly high requirements are imposed on the performance of the lithium-ion battery, such as light weight, durability, high voltage, high energy density, and high safety. The lithium-ion battery has an extremely high potential for application and expansion, especially in light electric vehicle, electric vehicle, and large-scale power storage industries.

At present, an electrochemical potential window of a commercial lithium-ion battery in the market is generally in the range of 3 to 4.2 V, and the application range of the lithium-ion battery is thus limited. When the operation voltage of the lithium-ion battery is greater than 4.5 V, an electrolyte in the lithium-ion battery is decomposed to generate oxygen and hydrogen, thus causing the expansion and degraded performance of the battery, and leading to an increased risk in use. Considering the development of the use of the high-voltage and high-power electric vehicles in the market, the demand for the lithium-ion battery capable of being discharged/charged at a high voltage will be increased rapidly.

In view of this, the present invention provides a lithium-ion battery and a method for fabricating the same. The lithium-ion battery thus fabricated can have a higher operation voltage.

### SUMMARY OF THE INVENTION

The present invention is directed to a lithium-ion battery, which includes an anode, a cathode, a separator, and an electrolyte solution. The cathode is disposed opposite to the anode. The separator is disposed between the anode and the cathode, where an accommodating region is defined by the anode, the cathode and the separator together. The electrolyte solution disposed within the accommodating region includes an organic solvent, a lithium salt and an additive. The additive includes a sulfonyl-containing species, and the additive accounts for 0.1 to 5 wt % based on the total weight of the electrolyte solution. The whole-cell potential of the lithium-ion battery is 4.5 V or above.

In the lithium-ion battery according to an embodiment of the present invention, the sulfonyl-containing species has at least one of the structures represented by Formula (1):

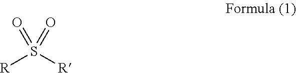

in which R and R′ each independently represent the same or different C₁₋₅ alkyl, C₁₋₅ alkenyl, or C₁₋₅ ether group, or R and R′ may form an alicyclic molecular structure.

In the lithium-ion battery according to an embodiment of the present invention, the sulfonyl-containing species represented by Formula (1) is selected from the group consisting of Formula (1-1), Formula (1-2), Formula (1-3), and Formula (1-4):

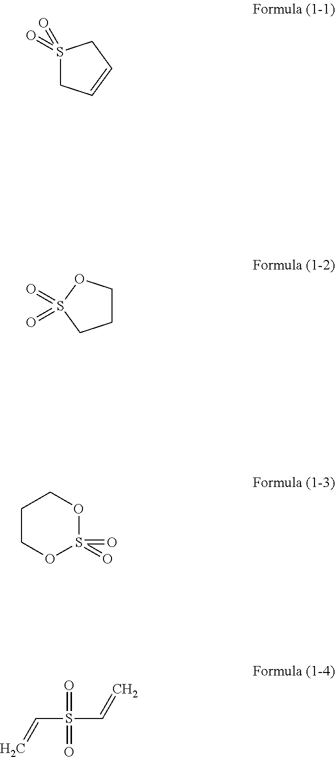

In the lithium-ion battery according to an embodiment of the present invention, the semi-cell lithium ion intercalation potential (reduction potential) of the anode is 0.2 V or below. In an embodiment, the anode includes a material selected from the group consisting of a carbon compound, a silicon compound, a tin compound, and a silicon-tin alloy compound.

In the lithium-ion battery according to an embodiment of the present invention, the semi-cell lithium ion deintercalation potential (oxidation potential) of the cathode is 4.5 V or above. In an embodiment, the cathode includes a material selected from the group consisting of LiNiₓMn₂₋ₓ O₄, LiMnPO₄, LiNiPO₄, LiCoPO₄, and a compound containing a polyanion group, in which 0<x<2.

The lithium-ion battery according to an embodiment of the present invention further includes a package structure encapsulating the anode, the cathode, and the separator.

The present invention is further directed to a method for fabricating a lithium-ion battery, which includes preparing an anode and a cathode respectively; separating the anode from the cathode with a separator, in which an accommodating region is defined by the anode, the cathode and the separator together; and adding an electrolyte solution to the accommodating region, in which the electrolyte solution includes an organic solvent, a lithium salt and an additive, the additive includes a sulfonyl-containing species, and the additive accounts for 0.1 to 5 wt % based on the total weight of the electrolyte solution. The whole-cell potential of the lithium-ion battery is 4.5 V or above.

In the method for fabricating a lithium-ion battery according to an embodiment of the present invention, the sulfonyl-containing species has at least one of the structures represented by Formula (1):

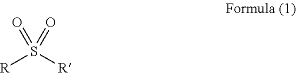

in which R and R′ each independently represent the same or different C₁₋₅ alkyl, C₁₋₅ alkenyl, or C₁₋₅ ether group, or R and R′ may form an alicyclic molecular structure.

In the method for fabricating a lithium-ion battery according to an embodiment of the present invention, the sulfonyl-containing species represented by Formula (1) is selected from the group consisting of Formula (1-1), Formula (1-2), Formula (1-3), and Formula (1-4):

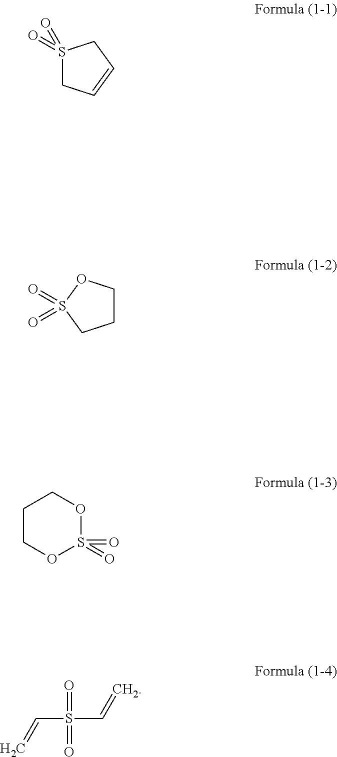

The method for fabricating a lithium-ion battery according to an embodiment of the present invention further includes encapsulating the anode, the cathode, and the separator with a package structure.

Based on the descriptions above, in the lithium-ion battery and the method for fabricating the same of the invention, the sulfonyl-containing species is added in the electrolyte solution to serve as the additive, and a high-voltage positive electrode material is used in combination for fabrication, so that the operation voltage and the performance of the lithium-ion battery are effectively improved, and the application range of the lithium-ion battery is thus broadened.

In order to make the features and advantages of the present invention more comprehensible, the present invention is described in detail below with reference to embodiments and accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a lithium-ion battery according to an embodiment of the present invention.

FIG. 2 is a flow chart of steps for fabricating a lithium-ion battery according to an embodiment of the present invention.

FIG. 3 shows curves illustrating a relation between charge and discharge cycle and discharge capacity of lithium-ion batteries of Example 1 and Comparative Example 1.

FIG. 4 shows curves illustrating a relation between charge and discharge cycle and discharge capacity of lithium-ion batteries of Example 2 and Comparative Example 2.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

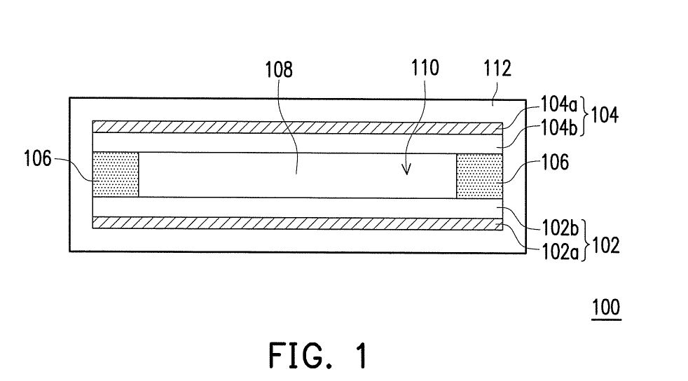

FIG. 1 is a schematic cross-sectional view of a lithium-ion battery according to an embodiment of the present invention. Referring to FIG. 1, a lithium-ion battery 100 includes an anode 102, a cathode 104, a separator 106, and an electrolyte solution 108.

The cathode 104 is disposed opposite to the anode 102. The separator 106 is disposed between the anode 102 and the cathode 104, where an accommodating region 110 is defined by the anode 102, the cathode 104 and the separator 106 together. The electrolyte solution 108 is disposed within the accommodating region. In an embodiment, the whole-cell potential of the lithium-ion battery 100 is about 4.5 V or above. In another embodiment, the whole-cell potential of the lithium-ion battery 100 is about 4.9 V or above.

The semi-cell lithium ion intercalation potential (reduction potential) of the anode 102 is 0.2 V or below. In an embodiment, the anode 102 includes an anode metal foil 102a and an anode active material 102b. The anode active material 102b may be coated or spluttered onto the anode metal foil 102a, to form an anode core. The anode metal foil 102a may be, for example, a copper foil, an aluminum foil, a nickel foil, or a stainless steel foil. The anode active material 102b may include a material selected from the group consisting of a carbon compound, a silicon compound, a tin compound, and a silicon-tin alloy compound. The carbon compound as the anode active material 102b may be, for example, artificial graphite, natural graphite, carbon particles, carbon fiber, carbon nano tubes, graphene, or a mixture or combination thereof. In an embodiment, when the anode active material 102b is made of carbon particles, the particle diamater thereof is in the range of about 5 μm to 30 μm. The silicon compound as the anode active material 102b may include, for example, silicon micron particles or silicon nano particles.

The semi-cell lithium ion deintercalation potential (oxidation potential) of the cathode 104 may be, for example, 4.5 V or above. In an embodiment, the cathode 104 includes a cathode metal foil 104a and a cathode active material 104b. The cathode active material 104b may be coated or spluttered onto the anode metal foil 104a, to form a cathode core. The cathode metal foil 104a may be, for example, a copper foil, an aluminum foil, a nickel foil, or a stainless steel foil. The cathode active material 104b may be, for example, a lithium mixed transition metal oxide, including a material selected from the group consisting of LiNiₓMn₂₋ₓO₄, LiMnPO₄, LiNiPO₄, LiCoPO₄, and a compound containing a polyanion group, in which 0<x<2. The polyanion group is a generic term for anions having a bulk molecular volume or an extremely high molecular weight, for example, (PO₄)⁻, (SiO₄)⁻, (PO₄F)⁻, (CO₃)⁻, (BO₃)⁻, and the like.

In an embodiment, each of the anode 102 and the cathode 104 further includes a polymer binder (not shown), to bind the anode active material 102b onto the anode metal foil 102a, and to bind the cathode active material 104b onto the cathode metal foil 104a, thereby improving the mechanical property of the anode core and the cathode core. A suitable polymer binder may be polyvinylidene fluoride (PVDF), styrene-butadiene rubber (SBR), polyamide, melamine resin, or a mixture thereof.

The separator 106 located between the anode 102 and the cathode 104 may include an insulation material, which may be, for example, polyethylene (PE), polypropylene (PP) or a multi-layer composite structure thereof such as PE/PP/PE.

The main components of the electrolyte solution 108 include an organic solvent, a lithium salt, and an additive, in which the organic solvent accounts for about 15-35 wt % based on the total weight of the electrolyte solution 108, the lithium salt accounts for about 5-20 wt % based on the total weight of the electrolyte solution 108, and the additive accounts for about 0.1-5 wt % based on the total weight of the electrolyte solution 108. The organic solvent may be, for example, γ-butyrolactone (GBL), ethylene carbonate (EC), propylene carbonate (PC), diethyl carbonate (DEC), propyl acetate (PA), dimethyl carbonate (DMC), ethylmethyl carbonate (EMC), or a combination thereof. The lithium salt may be, for example, LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, or a combination thereof.

It should be noted that in order to obtain the lithium-ion battery 100 which is rechargeable and dischargeable at a high voltage, the additive used in the electrolyte solution 108 may include a sulfonyl-containing species. In an embodiment, the sulfonyl-containing species may have at least one of the structures represented by Formula (1):

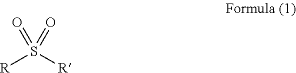

in which R and R′ each independently represent the same or different C₁₋₅ alkyl, C₁₋₅ alkenyl, or C₁₋₅ ether group, or R and R′ may form an alicyclic molecular structure.

Specifically, the sulfonyl-containing species represented by Formula (1) may be selected from the group consisting of butadiene sulfone, 1,3-propanesulfone, 1,3-propanediol cyclic sulfate, and divinyl sulfone represented by Formula (1-1), Formula (1-2), Formula (1-3), and Formula (1-4) below respectively:

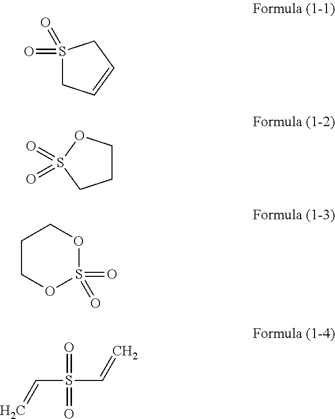

In an embodiment, the content of the sulfonyl-containing species in the electrolyte solution 108 is about 0.1-5 wt %. In another embodiment, the content of the sulfonyl-containing species in the electrolyte solution 108 is about 0.1-1 wt %. Based on the above, if the content of the sulfonyl-containing species in the electrolyte solution 108 is too low (for example, below 0.1 wt %), the electrolyte solution is decomposed to cause the decrease of the battery capacity when the battery voltage is higher than 4.5 V; and if the content of the sulfonyl-containing species in the electrolyte solution 108 is too high (for example, above 5 wt %), a passivation film (e.g. a solid electrolyte interface (SEI)) may grow thick on the surface of the electrode due to the high content of the additive, which may cause other side reactions that influence the performance of the battery.

In addition, the lithium-ion battery 100 may further include a package structure 112. The package structure 112 may be a common aluminum-foil package bag that encapsulates the anode 102, the cathode 104, and the separator 106.

It should be particularly noted that the operation voltage of the lithium-ion battery generally depends on the selection of the electrode materials and the electrochemical potential window of the electrolyte. In the embodiment of the present invention, an anode material and a cathode material that give a whole-cell potential difference of about 4.5 V or above are selected, and a molecule having a sulfonyl structure is used as the additive in the electrolyte solution for the lithium-ion battery, so as to improve the performance and operation voltage of the battery. Compared with a common commercial lithium-ion battery having a charge/discharge voltage in the range of 3-4.2 V, the additive in the electrolyte solution provided in the present invention can cause the lithium-ion battery to have an operation voltage that is higher than a maximum cut-off voltage of 4.2 V of a common lithium-ion battery, and have a high cycle life under a charge and discharge condition of 4.5 V or above. Therefore, the technology provided in the present invention can facilitate the improvement of the performance of the lithium-ion battery, and broaden the application range of the lithium-ion battery regarding high potential and high power uses.

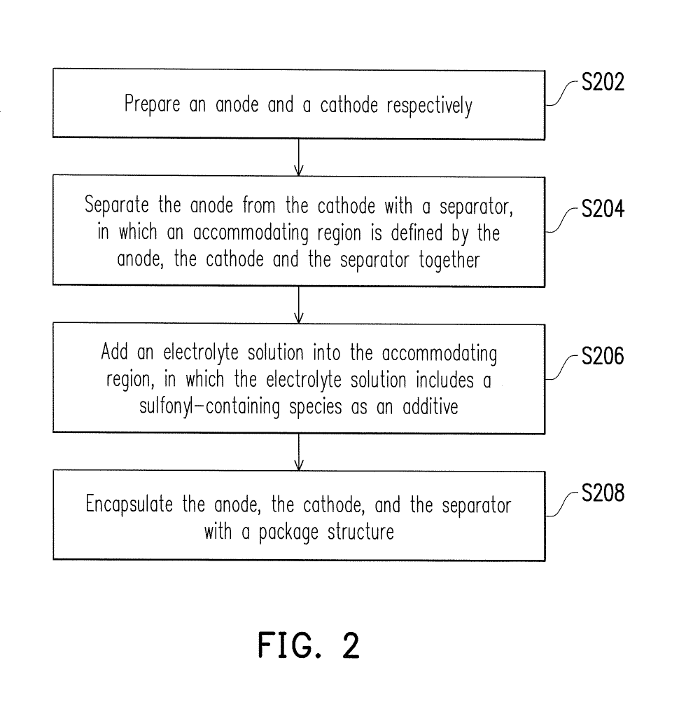

Hereinafter, a method for fabricating the lithium-ion battery of the present invention is described with the lithium-ion battery 100 shown in FIG. 1 as an example. It should be noted that the sequence of the process flow described below is provided for the purpose of implementing the present invention by those skilled in the art, instead of limiting the scope of the present invention. The materials and formulations of the members in the lithium-ion battery have been described in the foregoing embodiment, and thus are not further repeated herein again. FIG. 2 is a flow chart of steps for fabricating a lithium-ion battery according to an embodiment of the present invention.

Referring to FIG. 2, Step S202 is performed to prepare an anode and a cathode respectively. A method for preparing the anode may be, for example, coating or spluttering an anode active material onto an anode metal foil, and a method for preparing the cathode may be, for example, coating or spluttering a cathode active material onto a cathode metal foil. Then, an anode core and a cathode core are formed after suitable treatments (e.g. drying, compression, and cut). It should be particularly noted that the materials of the anode and the cathode can be properly selected such that a potential difference between the semi-cell lithium ion intercalation potential (reduction potential) of the anode material and the semi-cell lithium ion deintercalation potential (oxidation potential) of the cathode material is about 4.5 V or above.

Step S204 is performed to separate the anode from the cathode with a separator, in which an accommodating region is defined by the anode, the cathode and the separator together. In an embodiment, the separator may wind into a battery core after separating the anode from the cathode.

Step S206 is performed to add an electrolyte solution into the accommodating region, in which the electrolyte solution may include a sulfonyl-containing species as an additive. Specifically, the electrolyte solution is prepared mainly by mixing an organic solvent, a lithium salt, and the additive, in which the content of the sulfonyl-containing species in the electrolyte solution is about 0.1-5 wt %. Use of the sulfonyl-containing species as the additive can make the electrolyte solution become a high-voltage electrolyte solution, and can give a lithium-ion battery with an operation voltage of 4.5 V or above when a high-voltage positive electrode material is used in combination.

Step S208 is performed to encapsulate the anode, the cathode, and the separator with a package structure, so as to finish the fabrication of the lithium-ion battery structure.

Examples are numerated below to verify that the lithium-ion battery and the method for fabricating the same in the embodiment of the present invention can really improve the properties of the lithium-ion battery, such as a higher operation voltage, and a higher cycle life under a condition of high-voltage charge and discharge. The data and results obtained in the Examples below are provided only for illustration of the electrical property measurement results after multiple charge and discharge cycles of the lithium-ion battery fabricated in the embodiment of the present invention, but not intended to limit the scope of the present invention.

### Example 1

85 parts by weight of LiNi_{0.5}Mn_{1.5}O₄, 5 parts by weight of polyvinylidene difluoride (PVDF), and 10 parts by weight of acetylene black (conductive powder) were dispersed in N-methyl-2-pyrrolidinone (NMP), and a resulting slurry was coated onto an aluminum foil, and then dried, compressed, and cut, to form a cathode core.

95 parts by weight of graphite (maso carbon micro board, MCMB) and 5 parts by weight of PVDF were dispersed in NMP, and a resulting slurry was coated onto a copper foil, and then dried, compressed, and cut, to form an anode core.

In addition, 1 part by volume of ethylene carbonate (EC) and 1 part by volume of diethyl carbonate (DEC) were mixed and used as an organic solvent of an electrolyte solution. LiPF₆ was added, in a concentration of 1M, into the organic solvent and used as a lithium salt of the electrolyte solution, and then 1,3-propanediol cyclic sulfate was added and used as an additive of the electrolyte solution. 1,3-propanediol cyclic sulfate had a structure as shown in Formula (1-3), and the content thereof was 1.0 wt % based on the total weight of the electrolyte solution.

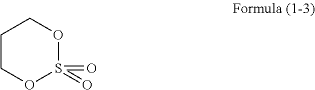

Then, PP was used as a separator and wound into a battery core after separating the anode from the cathode, in which an accommodating region was defined by the anode, the cathode and the separator together. The electrolyte solution was added into the accommodating region between the anode and the cathode. Finally, the structure was encapsulated with a package structure, thereby finishing the fabrication of the lithium-ion battery. Then, Electrical Property Measurement 1 was conducted as follows.

### Comparative Example 1

Except that the additive was not added in the process of fabricating the electrolyte solution, the fabrication of the battery, and the types and proportions of the solvent and the lithium salt in the electrolyte solution were the same as those in Example 1, so as to finish the fabrication of the lithium-ion battery in Comparative Example 1, and Electrical Property Measurement 1 was conducted as follows.

### Electrical Property Measurement 1

A. Battery Capacity

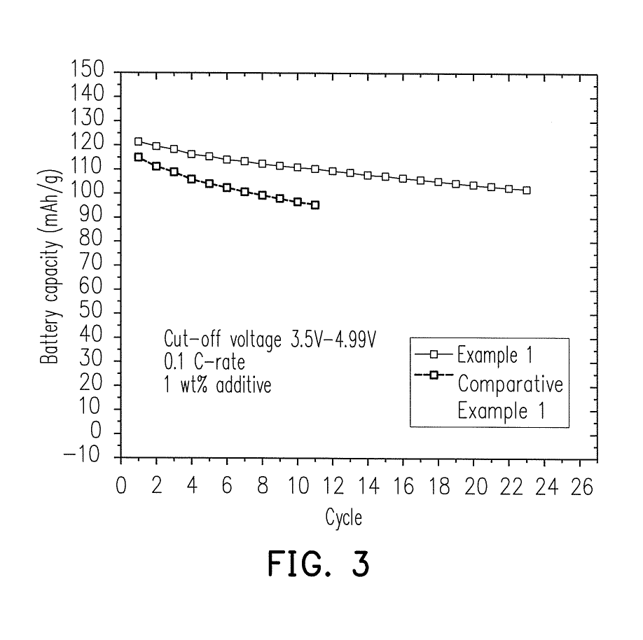

The lithium-ion batteries of Example 1 and Comparative Example 1 were respectively charged and discharged at a fixed current/voltage. First, the battery was charged to 4.99 V at a fixed current of 0.2 mA/cm², till the current was lower than or equal to 0.02 mA. Then, the battery was discharged to a cut-off voltage of 2.75 V at a fixed current of 0.2 mA/cm². The battery capacities (milliamp hours per gram, mAh/g) measured in discharge of the batteries of Example 1 and Comparative Example 1 were calculated and then plotted as shown in FIG. 3.

B. Charge and Discharge Cycle Test

The lithium-ion batteries of Example 1 and Comparative Example 1 were respectively charged and discharged at a fixed current/voltage. First, the battery was charged to 4.99 V at a fixed current of 0.25 mA, till the current was lower than or equal to 0.0025 mA. Then, the battery was discharged to a cut-off voltage of 2.75 V at a fixed current of 0.25 mA. The process was repeated 10-30 times. The battery capacities (mAh/g) measured in discharge of the batteries of Example 1 and Comparative Example 1 in each cycle were calculated and then plotted as shown in FIG. 3.

### Example 2

85 parts by weight of LiNi_{0.5}Mn_{1.5}O₄, 5 parts by weight of PVDF, and 10 parts by weight of acetylene black (conductive powder) were dispersed in N-methyl-2-pyrrolidinone (NMP), and a resulting slurry was coated onto an aluminum foil, and then dried, compressed, and cut, to form a cathode core.

95 parts by weight of graphite (MCMB) and 5 parts by weight of PVDF were dispersed in NMP, and a resulting slurry was coated onto a copper foil, and then dried, compressed, and cut, to form an anode core.

In addition, 1 part by volume of EC and 1 part by volume of DEC were mixed and used as an organic solvent of an electrolyte solution. LiPF₆ was added, in a concentration of 1M, into the organic solvent and used as a lithium salt of the electrolyte solution, and then divinyl sulfone was added and used as an additive of the electrolyte solution. Divinyl sulfone had a structure as shown in Formula (1-4), and the content thereof was 1.0 wt % based on the total weight of the electrolyte solution.

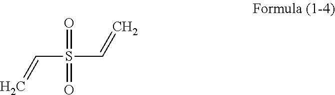

Then, PP was used as a separator and wound into a battery core after separating the anode from the cathode, in which an accommodating region was defined by the anode, the cathode and the separator together. The electrolyte solution was added into the accommodating region between the anode and the cathode. Finally, the structure was encapsulated with a package structure, thereby finishing the fabrication of the lithium-ion battery. Then, Electrical Property Measurement 2 was conducted as follows.

### Comparative Example 2

Except that the additive was not added in the process of fabricating the electrolyte solution, the fabrication of the battery, and the types and proportions of the solvent and the lithium salt in the electrolyte solution were the same as those in Example 2, so as to finish the fabrication of the lithium-ion battery in Comparative Example 2, and Electrical Property Measurement 2 was conducted as follows.

### Electrical Property Measurement 2

A. Battery Capacity

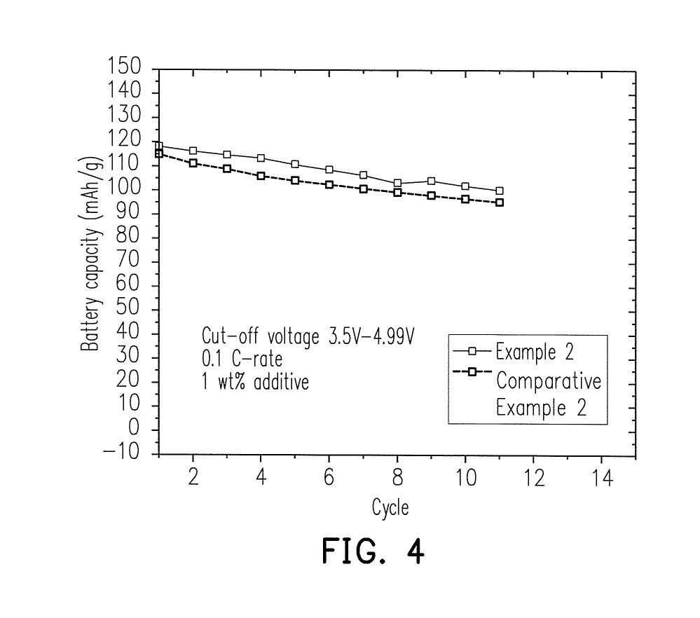

The lithium-ion batteries of Example 2 and Comparative Example 2 were respectively charged and discharged at a fixed current/voltage. First, the battery was charged to 4.99 V at a fixed current of 0.2 mA/cm², till the current was lower than or equal to 0.1 mA. Then, the battery was discharged to a cut-off voltage of 2.75 V at a fixed current of 0.2 mA/cm². The battery capacities (mAh/g) measured in discharge of the batteries of Example 2 and Comparative Example 2 were calculated and then plotted as shown in FIG. 4.

B. Charge and Discharge Cycle Test

The lithium-ion batteries of Example 2 and Comparative Example 2 were respectively charged and discharged at a fixed current/voltage. First, the battery was charged to 4.99 V at a fixed current of 0.25 mA, till the current was lower than or equal to 0.0025 mA. Then, the battery was discharged to a cut-off voltage of 2.75 V at a fixed current of 0.25 mA. The process was repeated 10 times. The battery capacities (mAh/g) measured in discharge of the batteries of Example 2 and Comparative Example 2 in each cycle were calculated and then plotted as shown in FIG. 4.

As seen from the test results in FIGS. 3 and 4, when the lithium-ion batteries are discharged for the first time, the battery capacities in Examples 1 and 2 in which the sulfonyl-containing species is used as the additive are obviously higher than those in Comparative Examples 1 and 2 in which no additive is added in the electrolyte solution. After multiple charge and discharge cycles of the lithium-ion batteries, the battery capacities in Examples 1 and 2 are still higher than those in Comparative Examples 1 and 2. It can be known that by using the related sulfonyl-containing compound as the additive in the lithium-ion battery of the present invention, the capacity of the lithium-ion battery can be increased by about 5-10%, so that the performance of the battery can be effectively improved, and the lithium-ion battery can be charged and discharged more efficiently.

To sum up, in the lithium-ion battery and the method for fabricating the same of the invention, the sulfonyl-containing species is used as the additive in the electrolyte solution, and an anode material and a cathode material that give a full-cell potential difference of about 4.5 V or above are used in combination. In such manner, the operation voltage of the lithium-ion battery is higher than a common commercial lithium-ion battery, and the lithium-ion battery still has a high cycle life under a condition of high-voltage charge and discharge. As such, a lithium-ion battery with improved performance and wide application range can be obtained with the formulation of the electrolyte solution provided in the present invention in combination with particular electrode materials.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lithium-ion battery, comprising:
an anode;
a cathode, disposed opposite to the anode;
a separator, disposed between the anode and the cathode, wherein an accommodating region is defined by the anode, the cathode and the separator together; and
an electrolyte solution, disposed within the accommodating region and comprising an organic solvent, a lithium salt and an additive, wherein the additive comprises a sulfonyl-containing species, and the additive accounts for 0.1 to 5 wt % based on a total weight of the electrolyte solution,
wherein a whole-cell potential of the lithium-ion battery is 4.5 V or above.

2. The lithium-ion battery according to claim 1, wherein the sulfonyl-containing species is at least one of compounds represented by Formula (1): 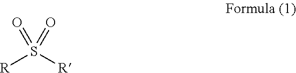
wherein R and R′ each independently represent the same or different C₁₋₅ alkyl, C₁₋₅ alkenyl, or C₁₋₅ ether group, or R and R′ form an alicyclic molecular structure.

3. The lithium-ion battery according to claim 2, wherein the sulfonyl-containing species represented by Formula (1) is selected from the group consisting of Formula (1-1), Formula (1-2), Formula (1-3), and Formula (1-4):

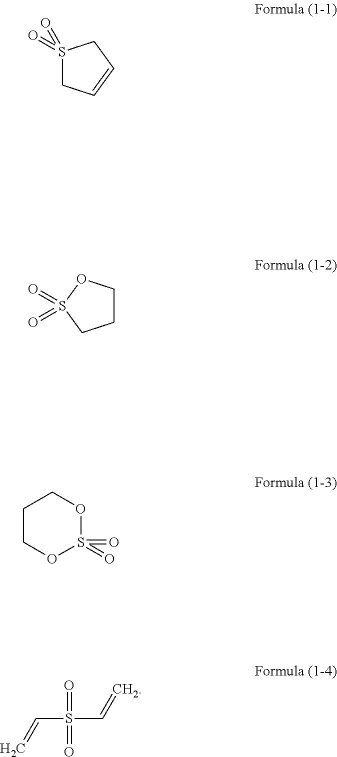

4. The lithium-ion battery according to claim 1, wherein a semi-cell lithium ion intercalation potential of the anode is 0.2 V or below.

5. The lithium-ion battery according to claim 4, wherein the anode comprises a material selected from the group consisting of a carbon compound, a silicon compound, a tin compound, and a silicon-tin alloy compound.

6. The lithium-ion battery according to claim 1, wherein a semi-cell lithium ion deintercalation potential of the cathode is 4.5 V or above.

7. The lithium-ion battery according to claim 6, wherein the cathode comprises a material selected from the group consisting of LiNiₓMn₂₋ₓO₄, LiMnPO₄, LiNiPO₄, LiCoPO₄, and a compound containing a compound containing a polyanion group, and 0<x<2.

8. The lithium-ion battery according to claim 1, further comprising a package structure encapsulating the anode, the cathode, and the separator.

9. A method for fabricating a lithium-ion battery, comprising:
preparing an anode and a cathode respectively;
separating the anode from the cathode with a separator, wherein an accommodating region is defined by the anode, the cathode and the separator together; and
adding an electrolyte solution to the accommodating region, wherein the electrolyte solution comprises an organic solvent, a lithium salt and an additive, the additive comprises a sulfonyl-containing species, and the additive accounts for 0.1 to 5 wt % based on a total weight of the electrolyte solution,
wherein a whole-cell potential of the lithium-ion battery is 4.5 V or above.

10. The method for fabricating a lithium-ion battery according to claim 9, wherein the sulfonyl-containing species is at least one of compounds represented by Formula (1): 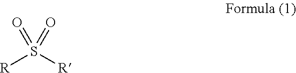
wherein R and R′ each independently represent the same or different C₁₋₅ alkyl, C₁₋₅ alkenyl, or C₁₋₅ ether group, or R and R′ form an alicyclic molecular structure.

11. The method for fabricating a lithium-ion battery according to claim 10, wherein the sulfonyl-containing species represented by Formula (1) is selected from the group consisting of Formula (1-1), Formula (1-2), Formula (1-3), and Formula (1-4):

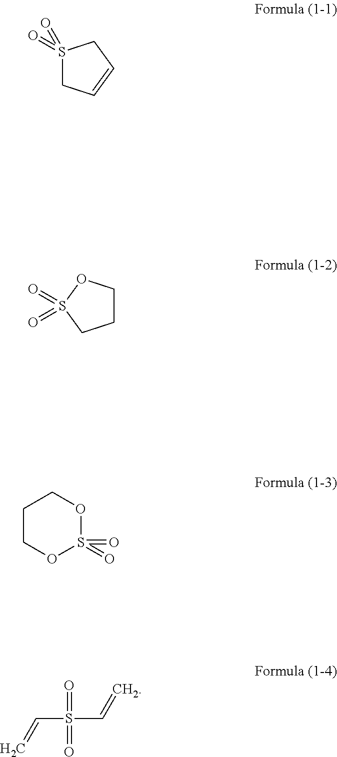

12. The method for fabricating a lithium-ion battery according to claim 9, further comprising encapsulating the anode, the cathode, and the separator with a package structure.
